(19) United States
(12) Patent Application Publication
(10) Pub. No.: US 2015/0074945 A1
(43) Pub. Date: Mar. 19, 2015

(54) PIVOT APPARATUS AND ELECTRONIC DEVICE USING PIVOT APPARATUS

(71) Applicant: HON HAI PRECISION INDUSTRY CO., LTD., New Taipei (TW)

(72) Inventors: YI-RU CHEN, New Taipei (TW); SAN-YI HUNG, New Taipei (TW)

(21) Appl. No.: 14/489,758

(22) Filed: Sep. 18, 2014

(30) Foreign Application Priority Data
Sep. 18, 2013 (TW) 102134005

(51) Int. Cl. E05D 7/00; E05D 3/02

(52) U.S. Cl. CPC E05D 7/00; E05D 3/02
USPC 16/386

(57) ABSTRACT

A pivot apparatus to allow the opening and closing together of two elements in the manner of a clamshell includes a first pivoting member defining a helical gap, a second pivoting member, and a motivating member. The first pivoting member and the motivating member are coupled to the second pivoting member from opposite directions. The motivating member has a retractable pole and a positioning post protruding from the retractable pole. When the retractable pole couples to the first pivoting member, the positioning post extends into and is guided by the helical gap. The retractable pole can move axially to motivate the positioning post to slide along the helical gap. The first pivoting member is rotated relative to the second pivoting member by the positioning post. The present disclosure further discloses an electronic device using the pivot apparatus.

### CROSS-REFERENCE TO RELATED APPLICATIONS

This application claims priority to Taiwanese Patent Application No. 102134005 filed on Sep. 18, 2013 in the Intellectual Property Office Ministry of Economic Affairs Republic of China, the contents of which are incorporated by reference herein.

### FIELD

The subject matter herein generally relates to mechanical linkages.

### BACKGROUND

Pivot apparatuses are widely used in various kinds of electronic devices, such as notebook computers, allowing them to open and close like a clamshell.

### BRIEF DESCRIPTION OF THE DRAWINGS

Implementations of the present technology will now be described, by way of example only, with reference to the attached figures.

FIG. 1 is an exploded, isometric view of a pivot apparatus of an embodiment.

FIG. 2 is similar to FIG. 1, but showing the pivot apparatus from another angle.

FIG. 3 is an assembled, isometric view of the pivot apparatus of FIG. 1.

FIG. 4 is a front view of the pivot apparatus of FIG. 3, showing the pivot apparatus in a locked position.

FIG. 5 is similar to FIG. 4, but showing the pivot apparatus in a first position.

FIG. 6 is similar to FIG. 4, but showing the pivot apparatus in a second position.

FIG. 7 is an exploded, isometric view of an electronic device using the pivot apparatus of an embodiment.

FIG. 8 is a partial and enlarged view of the electronic device of FIG. 7.

FIG. 9 is an assembled view of the electronic device of FIG. 7, showing the electronic device in a locked state.

FIG. 10 is similar to FIG. 9, but showing the electronic device in a first state.

FIG. 11 is similar to FIG. 9, but showing the electronic device in a second state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is in relation to a pivot apparatus and an electronic device using the pivot apparatus. The pivot apparatus includes a first pivoting member defining a helical gap therein, a second pivoting member configured to pivotally house the first pivoting member, and a motivating member pivotally coupled to the first pivoting member. The motivating member has a retractable pole pivotally mounted in the first pivoting member and a positioning post protruding from the retractable pole. The positioning post can slide in and follow the helical gap. When the retractable pole moves along its axial direction, the positioning post slides along the helical gap to motivate the first pivoting member to rotate relative to the second pivoting member. The electronic device includes a base and a cover pivotally attached to the base by the pivot apparatus.

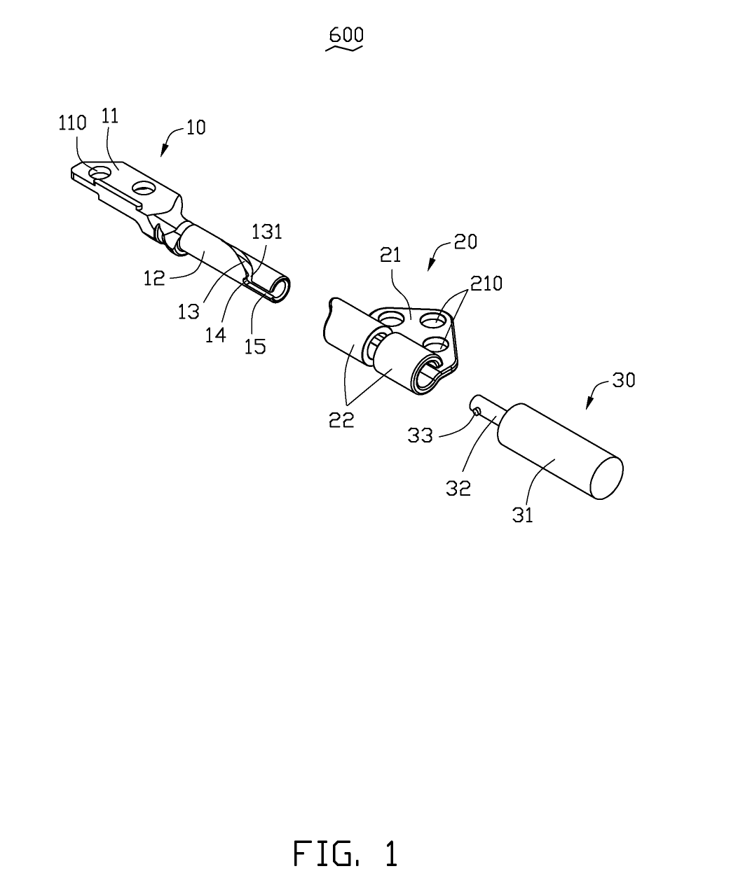

FIG. 1 illustrates a pivot apparatus 600 for pivotally connecting two elements. The pivot apparatus 600 includes a first pivoting member 10, a second pivoting member 20, and a motivating member 30.

The first pivoting member 10 includes a pivoting portion 12 and a first attaching portion 11 connecting to one end of the pivoting portion 12. The pivoting portion 12 is a hollow cylinder with a helical gap 13 defined therein. An axis of the helical gap 13 is the same as the axis of the pivoting portion 12. The first attaching portion 11 defines a plurality of mounting holes 110 and is configured to attach to an element.

The second pivoting member 20 includes a second attaching portion 21 configured to attach to another element, and a sleeve 22 configured for pivotally housing the pivoting portion 12. The second attaching portion 21 connects to a sidewall of the sleeve 22. A plurality of mounting holes 210 is defined on the second attaching portion 21. The first attaching portion 11 can be rotated relative to the second attaching portion 21 by the motivating member 30.

The motivating member 30 includes an inflator 31 and a retractable pole 32 connecting to the inflator 31. The retractable pole 32 is configured to be pivotally received in the pivoting portion 12. A positioning post 33 protrudes from a distal end of the retractable pole 32 and along a direction that is substantially perpendicular to the axial direction of the retractable pole 32. The positioning post 33 is configured to extend into, and to be guided by, the helical gap 13. In an embodiment, the motivating member 30 is a gas spring, which is gas-filled and the retractable pole 32 can move by the gas in the inflator 31.

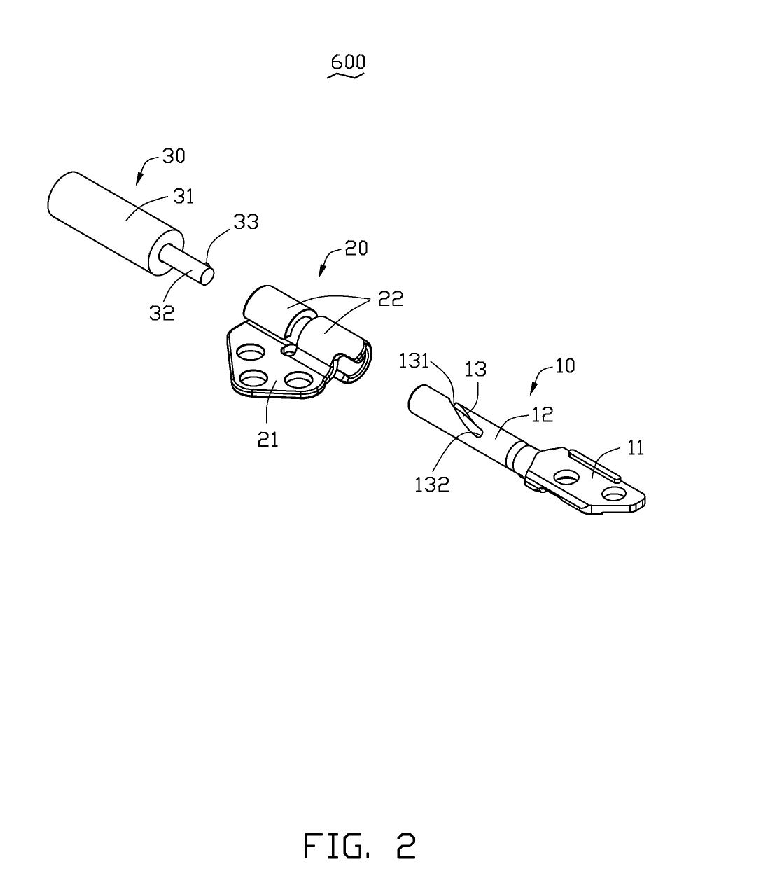

FIGS. 1-2 illustrate that the helical gap 13 includes a first end 131 and a second end 132 opposite to the first end 131. A distance between the first end 131 and the first attaching portion 11 is greater than that between the second end 132 and the first attaching portion 11. A notch 14 is defined in the pivoting portion 12 and configured to receive the positioning post 33 and prevent the positioning post 33 from sliding along the helical gap 13. The notch 14 communicates with the first end 131. A mounting slot 15 is defined in the pivoting portion 12 and extends along a direction parallel to the axis of the pivoting portion 12. One end of the mounting slot 15 communicates with the notch 14, and an opposite end of the mounting slot 15 is connected to the end of the pivoting portion 12. The mounting slot 15 is configured for allowing the positioning post 33 to slide into the notch 14.

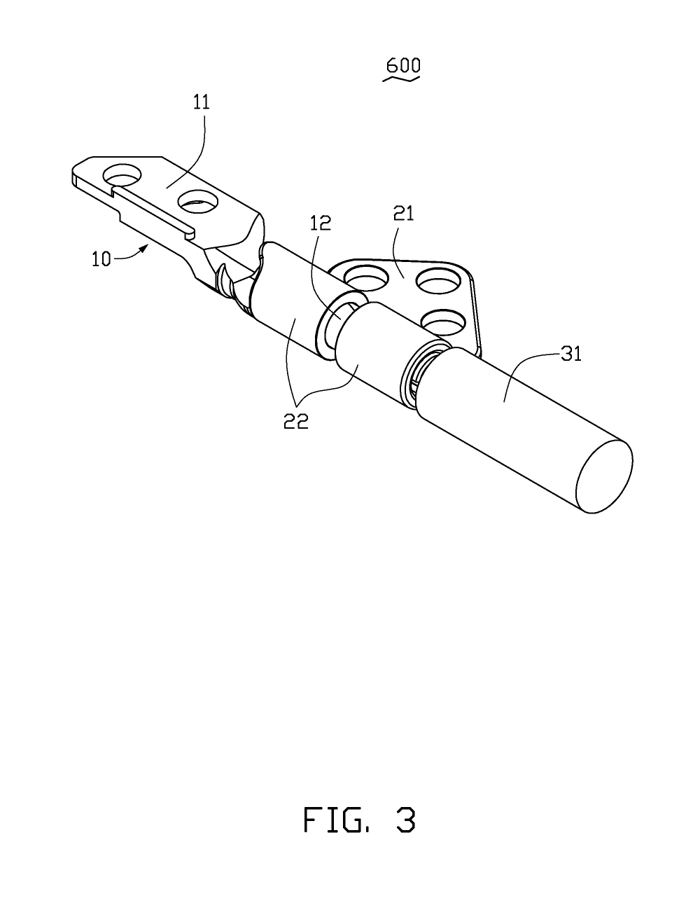

FIG. 3 illustrates an assembled the pivot apparatus 600. The first pivoting member 10 and the motivating member 30 couple to the second pivoting member 20 on opposite sides of the second pivoting member 20. The pivoting potion 12 is pivotally received in the sleeve 22, and the retractable pole 32 extends into the sleeve 22 and is pivotally received in the pivoting portion 12. The positioning post 33 slides into the notch 14 from the mounting slot 15. The inflator 31 and the first attaching portion 11 are located on opposite sides of the second pivoting member 20. A distance between the first attaching portion 11 and the retractable pole 32 is adjustable, and an angle between the first attaching portion 11 and the second attaching portion 21 varies in inverse proportion to the distance between the first attaching portion 11 and the retractable pole 32.

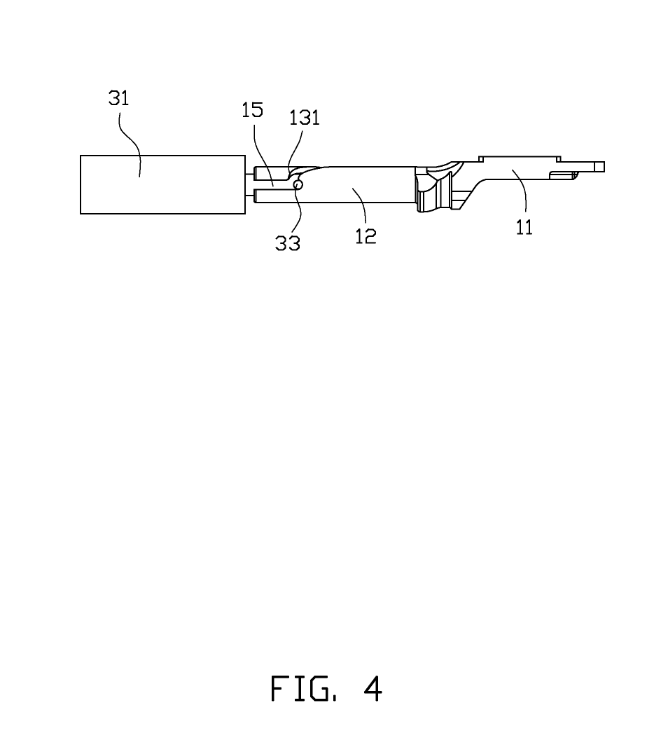

FIG. 4 illustrates the pivot apparatus 600 in a locked position. In this locked position, the retractable pole 32 is received in the inflator 31. The positioning post 33 is received in the notch 14 and resists an edge of the notch 14 so that the retractable pole 32 cannot slide axially. The notch 14 prevents the positioning post 33 from sliding along the helical gap 13.

The angle formed between the first attaching portion 11 and the second attaching portion 21 is thus locked.

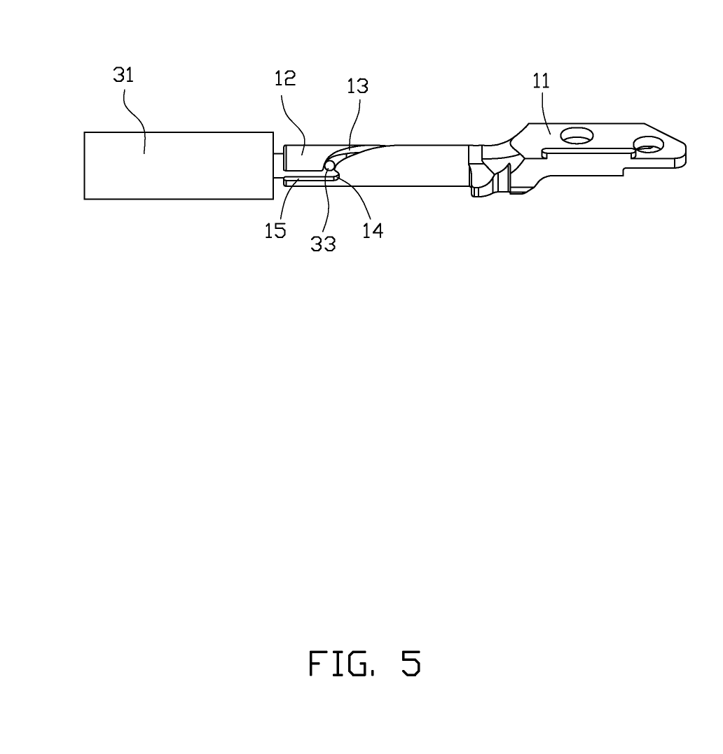

FIG. 5 illustrates the pivot apparatus 600 in a first position. The positioning post 33 can slide from the notch 14 to the helical gap 13 by rotating the first attaching portion 11 relative to the second attaching portion 21, so that the pivot apparatus 600 can be positioned in the first position from the locked position. In this first position, the positioning post 33 is disengaged from the notch 14 and extends into the first end 131 of the helical gap 13. A first angle is formed between the first attaching portion 11 and the second attaching portion 21.

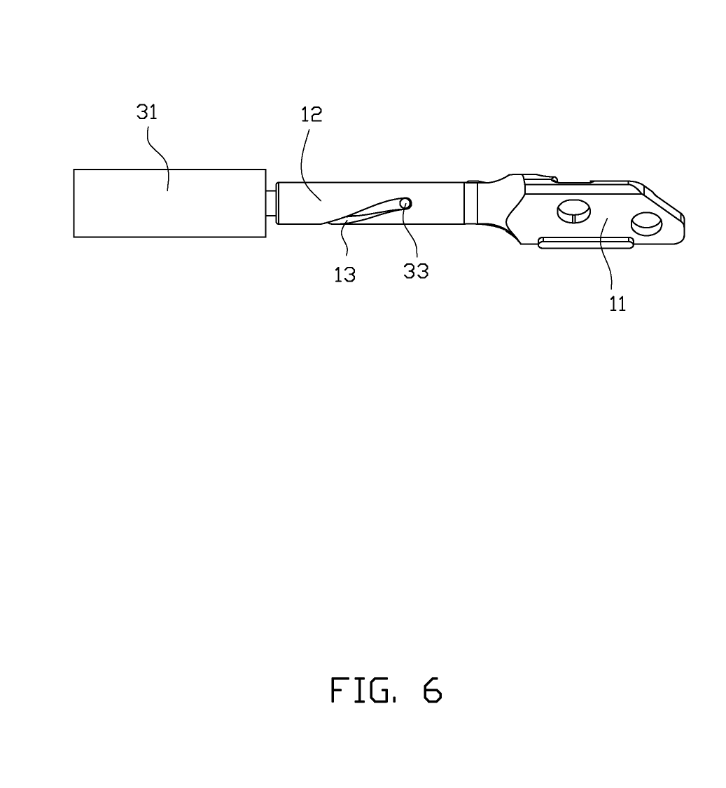

FIG. 6 illustrates the pivot apparatus 600 in a second position. The positioning post 33 can engage in and slide along the helical gap 13 by the retractable pole 32 moving outwards axially so that the pivot apparatus 600 can be positioned in the second position from the first position by the rotating the first pivoting member 10 relative to the second pivoting member 20. In this second position, the retractable pole 32 protrudes from the inflator 31. The positioning post 33 is slid along the helical gap 13 to the second end 132 by the retractable pole 32. The positioning post 33 resists an edge of the second end 132 and stops the movement of the retractable pole 32. The first attaching portion 11 is rotated relative to the second attaching portion 21 by the position post 33. A second angle is formed between the first attaching portion 11 and the second attaching portion 21.

The locked angle, the first angle, and the second angle are different. In one embodiment, the locked angle is less than the first angle. The first angle is less than the second angle.

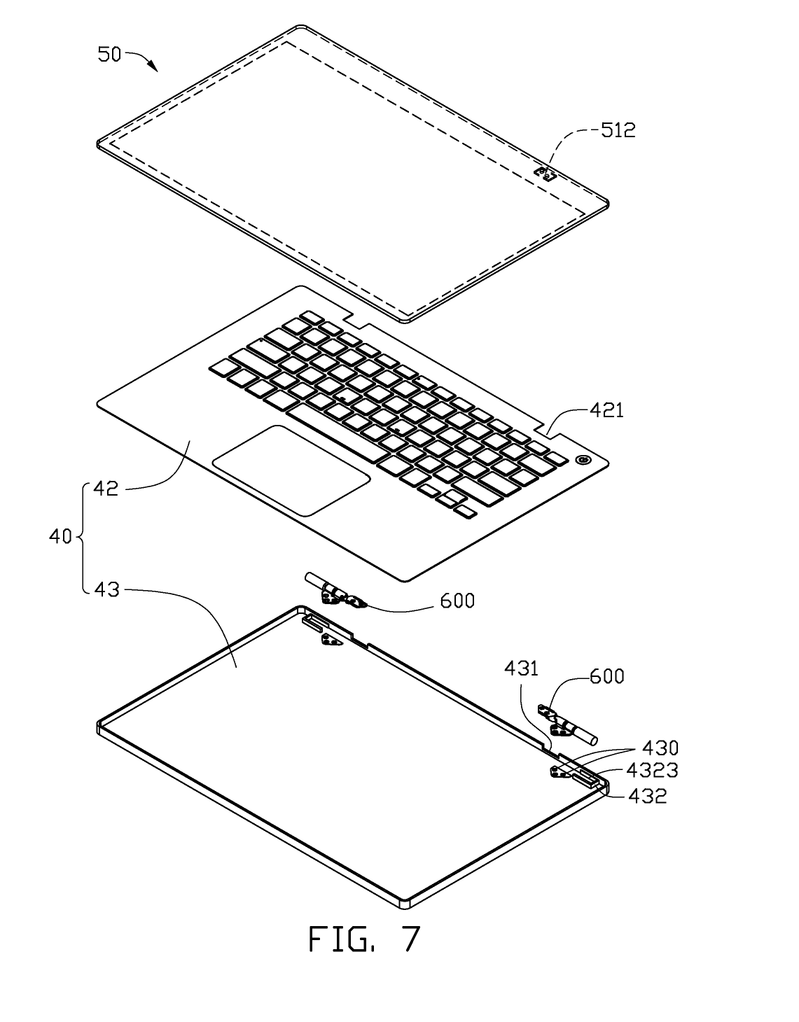

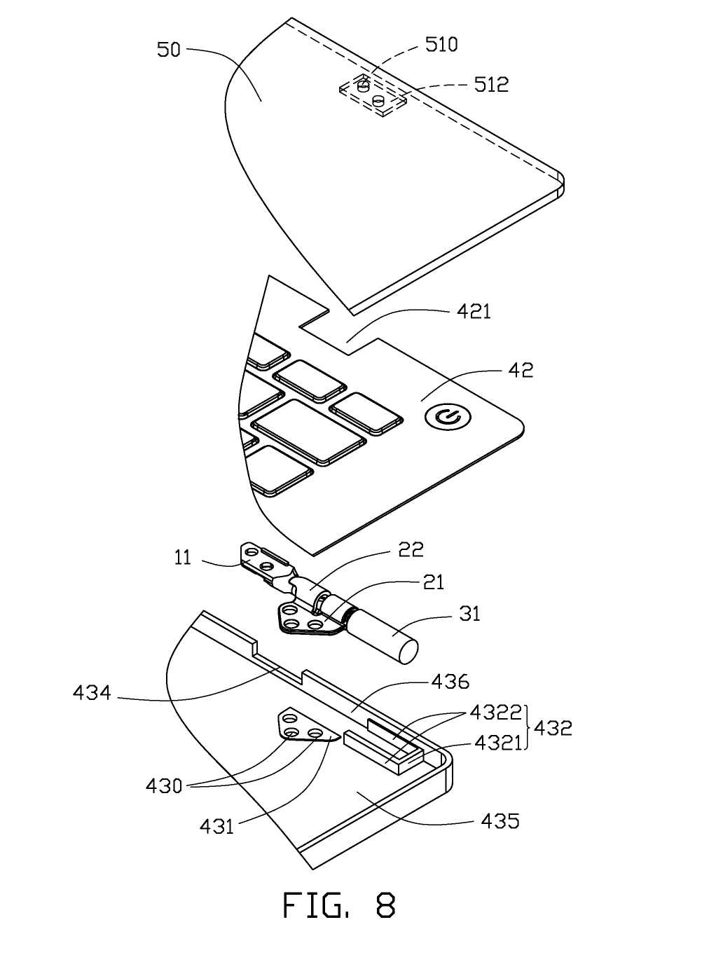

FIGS. 7-8 illustrate that the electronic device 700, with two pivot apparatuses 600 above, includes a base 40 and a cover 50 pivotally attached to the base 40 by the pivot apparatus 600. In an embodiment, the electronic device 700 is a notebook computer.

The base 40 includes a chassis 43 and a keyboard module 42 attached to the chassis 43. The chassis 43 includes a bottom 435 and a rear flange 436 with two first gaps 434 corresponding to the two first attaching portions 11. Two cutouts 421 are defined in the keyboard module 42 and aligned to the two first gaps 434 corresponding to the two first attaching portions 11. Two first mounting portions 512 are located on the cover 50 and configured to secure the two first attaching portions 11 to the cover 50. Each first mounting portion 512 aligns with a cutout 421. A plurality of mounting holes 510 is defined on the first mounting portion 512 to correspond to the plurality of mounting holes 110. Two second mounting portions 431 are located on the bottom 435 and configured to secure the two second attaching portions 21 to the base 40. A plurality of mounting holes 430 is defined on the second mounting portion 431 to correspond to the plurality of mounting holes 210.

Two resisting portions 432 are located on the bottom 435 corresponding to the two inflators 31. The resisting portions 432 are configured to resist and prevent the motivating members 30 from disengaging from the two first pivoting members 20. Each resisting portion 432 includes a resisting tab 4321 and a pair of stopping tabs 4322. An interior space 4323 is defined by the resisting tab 4321 and the pair of stopping tabs 4322 and is configured to receive each inflator 31. Each resisting portion 432 and each first mounting portion 512 are located on opposite sides of the second mounting portion 431.

Each pivot apparatus 600 can be attached to the base 40 and the cover 50 by screws (not shown) or other suitable manner. The cover 50 can be attached to and rotated relative to the base 40 on the pivot apparatus 600.

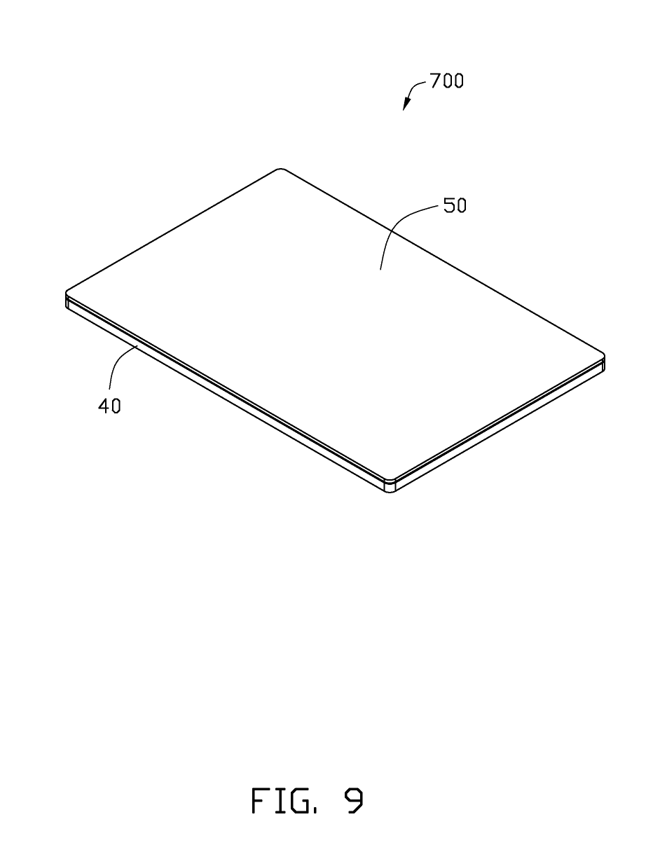

FIG. 9 illustrates assembly of the electronic device 700 in a locked state. In this locked state, the pivot apparatuses 600 are in the locked position (see FIG. 4). The cover 50 abuts and is parallel to the base.

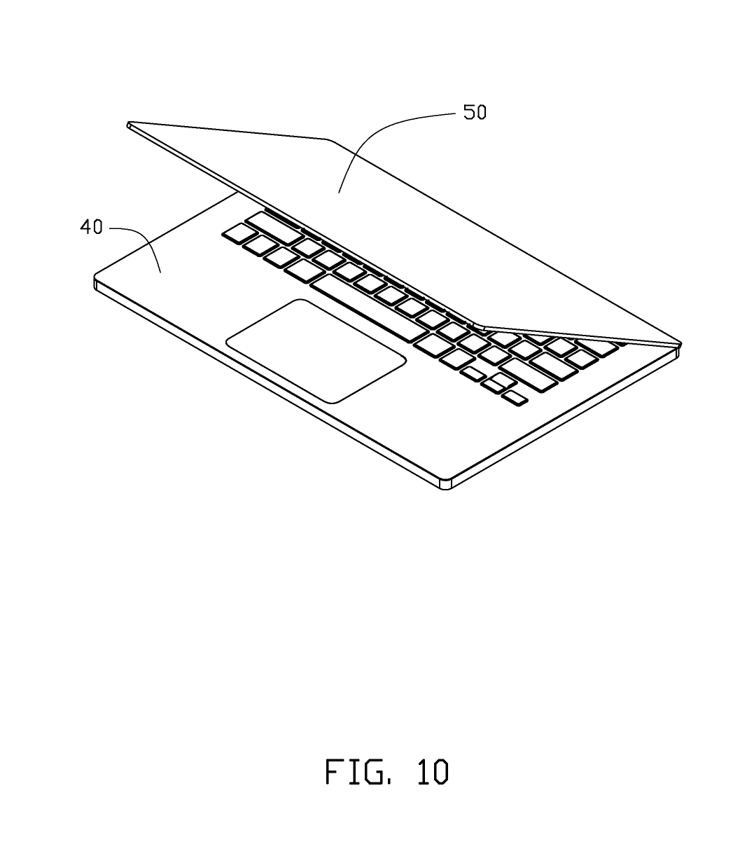

FIG. 10 illustrates the electronic device 700 in a first state. The electronic device 700 can be changed to the first state from the locked state by rotating the base 40 relative to the cover 50. The pivot apparatuses 600 are rotated by the cover 50 and the base 40. In this first state, the pivot apparatuses 600 are in the first position (see FIG. 5). A first angle is formed between the cover 50 and the base 40.

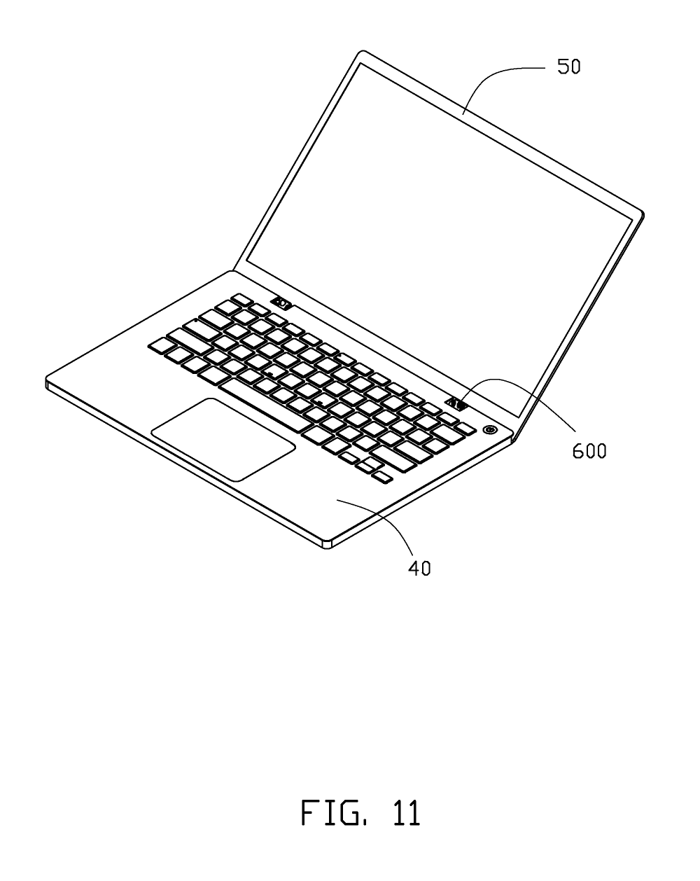

FIG. 11 illustrates the electronic device 700 in a second state. The cover 50 can be rotated relative to the base 40 to put into the second state by the pivot apparatuses 600. In this second state, the pivot apparatuses 600 are in the second position (see FIG. 6). A second angle is formed between the cover 50 and the base 40. The first angle is less than the second angle.

The embodiments shown and described above are only examples. Even though numerous characteristics and advantages of the present technology have been set forth in the foregoing description, together with details of the structure and function of the present disclosure, the disclosure is illustrative only, and changes may be made in detail, including matters of shape, size, and arrangement of the parts within the principles of the present disclosure, up to and including the full extent established by the broad general meaning of the terms used in the claims.

What is claimed is:

1. A pivot apparatus for pivotally connecting two elements comprising:
a first pivoting member defining a helical gap therein;
a second pivoting member configured to pivotally house the first pivoting member; and
a motivating member comprising a retractable pole pivotally mounted in the first pivoting member and a positioning post protruding from the retractable pole, the positioning post configured to slide along the helical gap;
wherein when the retractable pole moves along its axial direction, the positioning post slides along the helical gap to motivate the first pivoting member to rotate relative to the second pivoting member.

2. The pivot apparatus of claim 1, wherein the first pivoting member comprises a pivoting portion configured for housing the retractable pole; the helical gap is defined in the pivoting portion, and the pivoting portion has a hollow cylinder shape.

3. The pivot apparatus of claim 2, wherein the first pivoting member further comprises a first attaching portion connected to one end of the pivoting portion; the retractable pole is inserted into from an opposite end of the pivoting portion.

4. The pivot apparatus of claim 3, wherein the second pivoting member comprises a second attaching portion, when the retractable pole moves along an axial direction, a distance between the first attaching portion and the retractable pole is adjustable, and an angle between the firs attaching portion and the second attaching portion varies in inverse proportion to the distance between the first attaching portion and the retractable pole.

5. The pivot apparatus of claim 4, wherein the helical gap comprises a first end and a second end opposite to the first end; a distance between the first end and the first attaching portion is greater than that between the second end and the first attaching portion.

6. The pivot apparatus of claim 5, wherein when the positioning post slides to the first end, a first angle is formed between the first attaching portion and the second attaching portion, when the positioning post slides to the second end, a second angle is formed between the first attaching portion and the second attaching portion; the first angle is less than the second angle.

7. The pivot apparatus of claim 5, wherein a notch is defined in the pivoting portion, the notch is configured to receive the positioning post and prevents the positioning post from sliding along the helical gap.

8. The pivot apparatus of claim 7, wherein the notch communicates with the first end of the helical gap; the positioning post can slide from the notch to the helical gap by rotating the first pivoting member relative to the second pivoting member.

9. The pivot apparatus of claim 1, wherein the motivating member is a gas spring comprising an inflator, the retractable pole is retractably connected to the inflator and can be moved by the inflator, the positioning post extends from the retractable pole along a direction that is substantially perpendicular to the axial direction of the retractable pole.

10. A pivot apparatus for pivotally connecting two elements, comprising:
a first pivoting member having a tube-like portion with a helical gap therein;
a second pivoting member having a sleeve portion to pivotally house the tube-like portion of the first pivoting member; and
a motivating member with a retractable pole portion extending into the tube-like portion of the first pivoting member in a first axial direction, a positioning post extending out from the retractable pole portion and slidably engageable with the helical gap;
wherein, when the retractable pole portion moves in the first axial direction, the positioning post slides along the helical gap causing the first pivoting member to rotate relative to the second pivoting member.

11. An electronic device comprising:
a pivot apparatus having a first pivoting member, a second pivoting member configured to pivotally house the first pivoting member and a motivating member configured to pivotally couple to the first pivoting member; the first pivoting member defining a helical gap; the motivating member having a retractable pole pivotally mounted in the first pivoting member and a positioning post protruding from the retractable pole, the positioning post capable of sliding along the helical gap;
a base coupled to the second pivoting member; and
a cover pivotally attached to the base by being coupled to the first pivoting member;
wherein when the retractable pole moves along its axial direction, the positioning post slides along the helical gap to motivate the first pivoting member to rotate relative to the second pivoting member; the cover is rotated relative to the base by the pivot apparatus.

12. The electronic device of claim 11, wherein the base comprises a second mounting portion configured to secure the second pivoting member to the base; the cover comprises a first mounting portion configured to secure the first pivoting member to the cover.

13. The electronic device of claim 12, wherein the base further comprises a resisting portion configured to resist and preventing the motivating member from disengaging from the first pivoting member.

14. The electronic device of claim 13, wherein the first pivoting member is housed in the second pivoting member from one side of the second pivoting member, the motivating member is housed in the first pivoting member from an opposite side of the second pivoting member.

15. The electronic device of claim 14, wherein the resisting portion and the first mounting portion are on opposite sides of the second mounting portion.

16. The electronic device of claim 13, wherein the motivating member is a gas spring comprising an inflator, the retractable pole is retractably connected to the inflator, the retractable pole is received into the second pivoting member and coupled to the first pivoting member, the inflator locates on one side of the second pivoting member.

17. The electronic device of claim 16, wherein the positioning post extends from the retractable pole along a direction that is substantially perpendicular to the axial direction of the retractable pole.

18. The electronic device of claim 16, wherein the resisting portion comprises a resisting tab and a pair of stopping tabs; an interior space is cooperatively defined by the resisting tab and the pair of stopping tabs and configured to receive the inflator.

19. The electronic device of claim 12, wherein the first pivoting member comprises a first attaching portion corresponding to the first mounting portion and a pivoting portion configured for housing the retractable pole; the attaching portion connects to one end of the pivoting portion, the retractable pole inserts into the pivoting portion from an opposite end of the pivoting portion.

20. The electronic device of claim 19, wherein the second pivoting member comprises a second attaching portion corresponding to the second mounting portion and a sleeve configured for pivotally house the pivoting portion, the second attaching portion connects to a sidewall of the sleeve; the first attaching portion can be rotated relative to the second attaching portion by the motivation of retractable pole.
